(19) United States
(12) Patent Application Publication
(10) Pub. No.: US 2021/0049354 A1
(43) Pub. Date: Feb. 18, 2021

(54) HUMAN OBJECT RECOGNITION METHOD, DEVICE, ELECTRONIC APPARATUS AND STORAGE MEDIUM

(71) Applicant: Baidu Online Network Technology (Beijing) Co., Ltd, Beijing (CN)

(72) Inventor: Leilei Gao, Beijing (CN)

(73) Assignee: Baidu Online Network Technology (Beijing) Co., Ltd., Beijing (CN)

(21) Appl. No.: 16/797,222

(22) Filed: Feb. 21, 2020

(30) Foreign Application Priority Data
Aug. 16, 2019 (CN) 201910760681.4

(51) Int. Cl. G06K 9/00; G06K 9/62

(52) U.S. Cl. CPC G06K 9/00362; G06K 9/00288; G06K 9/6256; G06K 9/00711

(57) ABSTRACT

A human object recognition method and device, an electronic apparatus and a storage medium are provided, which are related to a field of image recognition technology. A specific implementation includes: receiving a human object recognition request corresponding to a current video frame in video stream; extracting a physical characteristic in the current video frame; matching the physical characteristic in the current video frame with a physical characteristic in a first video frame of the video stream stored in a knowledge base; and taking a first human object identifier in the first video frame as a recognition result of the human object recognition request, in a case where the physical characteristic in the current video frame is successfully matched with the physical characteristic in the first video frame.

### CROSS-REFERENCE TO RELATED APPLICATION

This application claims priority to Chinese patent application No. 201910760681.4, filed on Aug. 16, 2019, which is hereby incorporated by reference in its entirety.

### TECHNICAL FIELD

The present application relates to a field of information technology, and in particular, to a field of image recognition technology.

### BACKGROUNDS

While watching a video, a user may want to query information of a human object in the video. However, when a user issues a query request, it may happen that a playback of a video frame containing a human object's front face of video images has been completed. Thus, only a side face or a back of a human object is presented in a current video frame, or a face in a current video frame is not clear. In this case, an identity of the human object cannot be accurately recognized by using a face recognition technology, such that the recognition often fails. A recognition rate and satisfaction degree may be improved through pausing a video frame containing a human object's front face or capturing the moment at which a human object's front face appears, and thus the user experience is poor.

### SUMMARY

A human object recognition method and device, an electronic apparatus, and a storage medium are provided according to embodiments of the application, to solve at least the above technical problems in the existing technology.

In a first aspect, a human object recognition method is provided according to an embodiment of the application. The method includes:

receiving a human object recognition request corresponding to a current video frame of video stream;

extracting a physical characteristic in the current video frame;

matching the physical characteristic in the current video frame with a physical characteristic in a first video frame of the video stream stored in a knowledge base; and

taking a first human object identifier in the first video frame as a recognition result of the human object recognition request, in a case where the physical characteristic in the current video frame is successfully matched with the physical characteristic in the first video frame.

In an embodiment of the present application, when a human object recognition request is issued, information of a human object in a video may be queried based on a physical characteristic in a current video frame, without the need for capturing, by a user, a video frame with a human object's front face, so that a convenient query service may be provided, thereby improving user viscosity and bringing good user experience.

In an implementation, before the receiving a human object recognition request corresponding to a current video frame of a video stream, the method further includes:

performing a face recognition on a second video frame of the video stream to obtain a second human object identifier in the second video frame, wherein a human object's face is included in an image of the second video frame;

extracting a physical characteristic in the second video frame and a physical characteristic in the first video frame, wherein no human object's face is included in an image of the first video frame;

taking the second human object identifier as the first human object identifier in the first video frame, in a case where the physical characteristic in the second video frame is successfully matched with the physical characteristic in the first video frame; and

storing the first video frame and the first human object identifier in the first video frame, in the knowledge base.

In an embodiment of the present application, as a knowledge base is improved by analyzing a video stream, the accuracy of a human object recognition is improved.

In an implementation, before the performing a face recognition on a second video frame of the video stream, the method further includes:

capturing at least one first video frame and at least one second video frame from the video stream.

In an embodiment of the present application, continuous video frames in at least one time window in which a feature of a human object's face corresponds to a physical characteristic are captured in advance, thereby ensuring that an effective recognition result is generated.

In an implementation, the human object recognition request includes an image of the current video frame, wherein the image of the current video frame is obtained through taking a screenshot or capturing an image by a playback terminal of the video stream.

In an embodiment of the present application, when a human object recognition request is sent by a playback terminal of the video stream, an image of the current video frame needs to be included in the human object recognition request, and then real image data may be obtained through taking a screenshot or capturing an image.

In a second aspect, a human object recognition device is provided according to an embodiment of the application. The device includes:

a receiving unit, configured to receive a human object recognition request corresponding to a current video frame of a video stream;

an extracting unit, configured to extract a physical characteristic in the current video frame;

a matching unit, configured to match the physical characteristic in the current video frame with a physical characteristic in a first video frame of the video stream stored in a knowledge base; and

a recognition unit, configured to take a first human object identifier in the first video frame as a recognition result of the human object recognition request, in a case where the physical characteristic in the current video frame is successfully matched with the physical characteristic in the first video frame.

In an implementation, the device further comprises a knowledge base construction unit, the knowledge base construction unit includes:

a face recognition sub-unit, configured to perform face recognition on a second video frame of the video stream to obtain a second human object identifier in the second video frame, before receiving the human object recognition request corresponding to the current video frame of the video stream, wherein a human object's face is comprised in an image of the second video frame;

an extraction sub-unit, configured to extract a physical characteristic in the second video frame and a physical characteristic in the first video frame, wherein no human object's face is included in an image of the first video frame;

an identification sub-unit, configured to take the second human object identifier as the first human object identifier in the first video frame, in a case where the physical characteristic in the second video frame is successfully matched with the physical characteristic in the first video frame; and

a storage sub-unit, configured to store the first video frame and the first human object identifier in the first video frame, in the knowledge base.

In an implementation, the knowledge base construction unit further comprises a capturing sub-unit configured to:

capture at least one first video frame and at least one second video frame from the video stream, before performing the face recognition on the second video frame of the video stream.

In an implementation, the human object recognition request includes an image of the current video frame, the image of the current video frame is obtained through taking a screenshot or capturing an image by a playback terminal of the video stream.

In a third aspect, an electronic apparatus is provided according to an embodiment of the application. The electronic apparatus includes:

at least one processor; and

a memory communicated with the at least one processor; wherein,

instructions executable by the at least one processor are stored in the memory, the instructions, when executed by the at least one processor, cause the at least one processor to implement the method provided by any one of the embodiments of the present application.

In a fourth aspect, a non-transitory computer-readable storage medium including computer instructions stored thereon is provided according to an embodiment of the application, wherein the computer instructions cause a computer to implements the method provided by any one of the embodiments of the present application.

An embodiment in the above application has the following advantages or beneficial effects: points of interest are directly recognized from content related to an information behavior of a user, so that it is ensured that points of interest pushed to a user may match with intention of the user, rendering good user experience. As points of interest are directly recognized from content related to an information behavior of a user, the problem that pushed points of interest do not meet the user's needs is avoided, thereby improving user experience.

Other effects of the foregoing optional implementations will be described below in conjunction with specific embodiments.

### BRIEF DESCRIPTION OF THE DRAWINGS

The drawings are used to better understand the solution and are not to be construed as limiting the present application.

FIG. 1 is a schematic diagram showing a human object recognition method according to an embodiment of the application;

FIG. 2 is a schematic diagram showing a human object recognition method according to an embodiment of the application;

FIG. 3 is a flowchart showing an example of a human object recognition method according to the application;

FIG. 4 is a schematic structural diagram showing a human object recognition device according to an embodiment of the application;

FIG. 5 is a schematic structural diagram showing a human object recognition device according to an embodiment of the application;

FIG. 6 is a schematic structural diagram of showing a human object recognition device according to an embodiment of the application; and

FIG. 7 is a block diagram showing an electronic apparatus for implementing a human object recognition method in an embodiment of the application.

### DETAILED DESCRIPTION OF THE EMBODIMENTS

In the following, with reference to the accompanying drawings, exemplary embodiments of the present application are described below, which include various details of the embodiments of the present application to facilitate understanding and should be considered as merely exemplary. Therefore, those ordinary skilled in the art should recognize that various changes and modifications can be made to the embodiments described herein without departing from the scope and spirit of the application. Also, for clarity and conciseness, descriptions for public knowledge of functions and structures are omitted in the following descriptions.

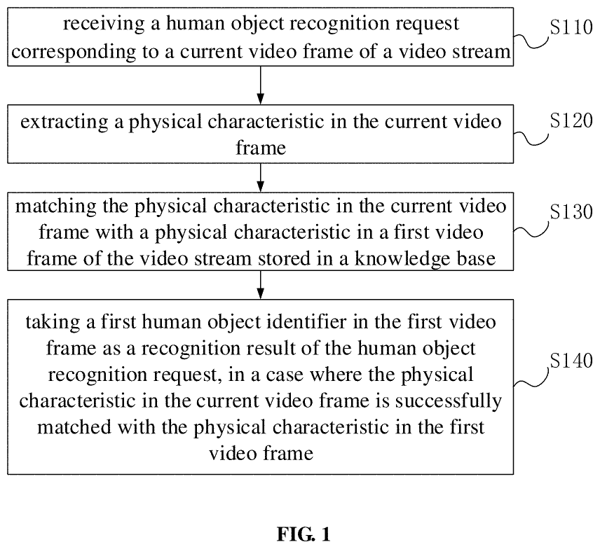

FIG. 1 is a schematic diagram showing a human object recognition method according to a first embodiment of the present application. As shown in FIG. 1, the human object recognition method includes the following steps.

At S110, a human object recognition request corresponding to a current video frame of video stream is received.

At S120, a physical characteristic in the current video frame is extracted.

At S130, the physical characteristic in the current video frame is matched with a physical characteristic in a first video frame of the video stream stored in a knowledge base.

At S140, a first human object identifier in the first video frame is taken as a recognition result of the human object recognition request, in a case where the physical characteristic in the current video frame is successfully matched with the physical characteristic in the first video frame.

While watching a video, a user may want to query information of a human object in the video. For example, a user may want to query who an actor playing a role in a current video frame is and may further want to query relevant information of the actor. In this case, while watching the video, the user may issue a human object recognition request through a playback terminal used for watching the video, such as a mobile phone, a tablet computer, a notebook computer, and the like. The human object recognition request may include information of the current video frame of the video stream. For example, the human object recognition request may include an image of the current video frame of the video stream. The user sends the human object recognition request to a server through the playback terminal for playing the video stream. In S110, the server receives a human object recognition request carrying information of the current video frame.

In a case, the image of the current video frame may contain the front face of a human object in the video. In this case, a human object recognition may be performed on the current video frame through a face recognition technology. In another case, it is possible that only a side face or a back of a human object is presented in the current video frame, or a human object's face is not clear in the current video frame, so that an identity of the human object cannot be accurately recognized by using the face recognition technology. In the above S120, a physical characteristic in the current video frame is extracted and used to perform a human object recognition.

Generally, images in parts of video frames of a video stream contain human object's front face, which are clear. These parts of the video frames are called second video frames. Also, images in some other parts of video frames only contain a side face or a back rather than a human object's front face, or a human object's face in the video frame is not clear. These parts of the video frames are called first video frames.

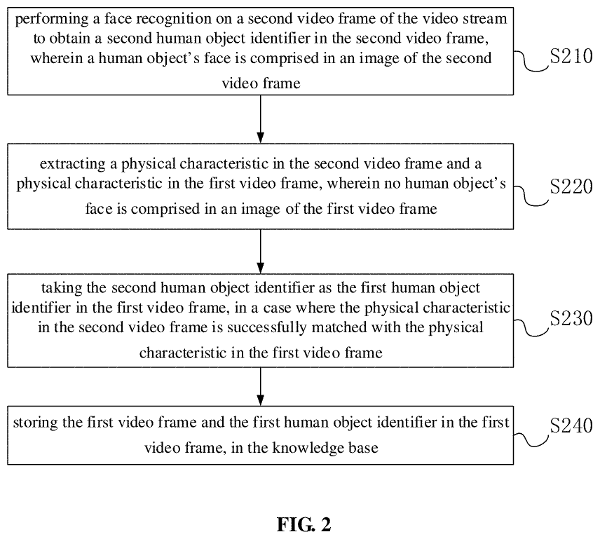

FIG. 2 is a schematic diagram showing a human object recognition method according to an embodiment of the application. As shown in FIG. 2, in an implementation, before the receiving a human object recognition request corresponding to a current video frame of a video stream at S110 in FIG. 1, the method further includes the following steps.

At S210, a face recognition is performed on a second video frame of the video stream to obtain a second human object identifier of the second video frame, wherein a human object's face is included in an image of the second video frame.

At S220, a physical characteristic in the second video frame and a physical characteristic in the first video frame are extracted, wherein no human object's face is included in an image of the first video frame.

At S230, the second human object identifier is taken as the first human object identifier in the first video frame, in a case where the physical characteristic in the second video frame is successfully matched with the physical characteristic in the first video frame.

At S240, the first video frame and the first human object identifier in the first video frame is stored in the knowledge base.

In order to perform a human object recognition on a first video frame, a face recognition may be performed on a second video frame of a video stream in advance, to obtain a second human object identifier, and physical characteristics, such as height, shape, clothing, in the first video frame and in the second video frame are extracted. In a case where the physical characteristics in the first video frame is matched with the physical characteristic in the second video frame, the obtained second human object identifier in the second video frame is marked to the first video frame. The obtained physical characteristic and the corresponding human object identifier in the first video frame are stored in the knowledge base.

In an embodiment of the present application, the use of a knowledge base for storing a human object identifier corresponding to a video frame has obvious advantages. The structure of the knowledge base allows knowledge stored therein to be efficiently accessed and searched during its use, the knowledge in the base may be easily modified and edited, at the same time, consistency and completeness of the knowledge in the base may be checked. In the process of establishing a knowledge base, original information and knowledge should be collected and sorted on a large scale, and then be classified and stored according to a certain method. Further, corresponding search means may be provided. For example, in the above method, a human object identifier corresponding to the first video frame is obtained by performing a face recognition on the second video frame and matching the physical characteristic in the second video frame with the physical characteristic in the first video frame. After such a process, a large amount of tacit knowledge is codified and digitized, so that the information and knowledge become ordered from an original chaotic state. In this way, a retrieval of the information and knowledge is facilitated, and a foundation is laid for an effective use of the information and knowledge. As the knowledge and information becomes ordered, time for searching and utilizing the knowledge and information is greatly reduced, thereby greatly accelerating a speed of providing query services by a service system based on the knowledge base.

In an embodiment of the present application, as a knowledge base is improved by analyzing a video stream, the accuracy of a human object recognition is improved.

As mentioned above, a physical characteristic in the first video frame and a corresponding human object identifier have been stored in the knowledge base, so a physical characteristic in the current video frame is matched with the physical characteristic in the first video frame of the video stream stored in the knowledge base in S130. In a case where physical characteristic in the current video frame the is successfully matched with the physical characteristic in the first video frame of the video stream stored in the knowledge base, it indicates that the human object in the current video frame image being played by the user is the same one as the human object in the first video frame image of the knowledge base. The first human object identifier in the first video frame is taken as a recognition result of the human object recognition request in S140.

In an embodiment of the present application, when a human object recognition request is issued, it is unnecessary to capture a video frame with the front face of the human object by a user, and information of a human object in the video may be queried based on a physical characteristic in the captured video frame. Thus, a convenient query service can be provided, thereby improving user viscosity and bringing good user experience.

In an implementation, before the performing a face recognition on a second video frame of the video stream, the method further includes the following step.

At least one first video frame and at least one second video frame are captured from the video stream.

In an embodiment of the present application, continuous video frames in at least one time window in which a feature of a human object's face corresponds to a physical characteristic are captured in advance, thereby ensuring that an effective recognition result is generated.

In an example, a video stream may be extracted from a video base in advance, to train a model for human object recognition. A physical characteristic in a first video frame generated by the trained model and a corresponding human object identifier are then stored in a knowledge base. For example, a group of images may be captured from the video stream to train the model. In a video stream, a correspondence between a feature of a human object's face and a physical characteristic does not always exist, but usually exists in a relatively short time window. Therefore, continuous video frames in at least one time window may be captured to train the model.

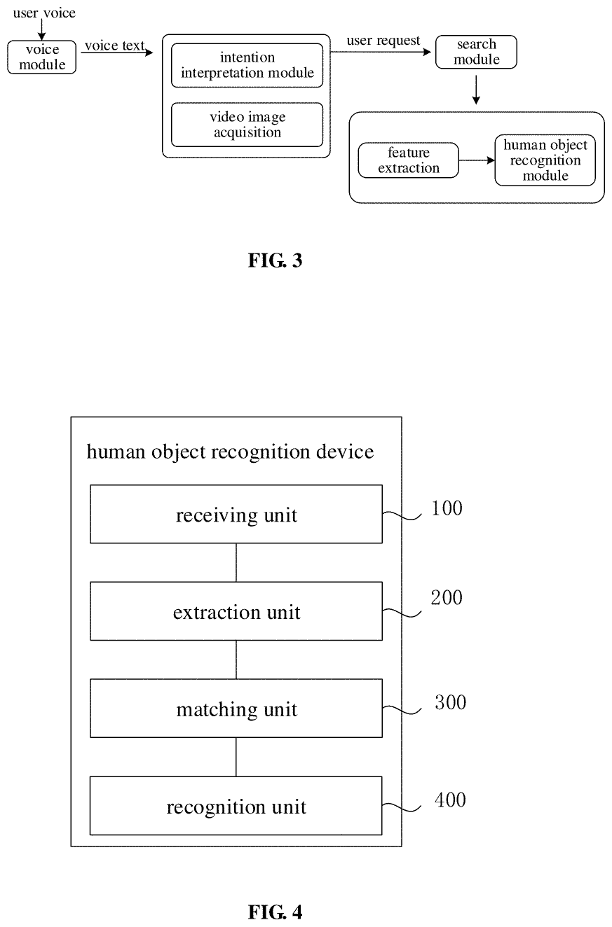

FIG. 3 is a flowchart showing an example of a human object recognition method according to the application. As shown in FIG. 3, voice information of a user may be received by a voice module. For example, a user may query: “who is this character?” or “who is this star?” After receiving the user's voice information, the voice module converts the voice information into text information, and then sends the text information to an intention interpretation module. The intention interpretation module performs a semantic interpretation on the text information and recognizes a user intention, which is that the user intends to query information of the star in the video. Next, the intent interpretation module sends the user request to a search module. In the example shown in FIG. 3, the voice module, the intention interpretation module, and a video image acquisition module may be provided by a playback terminal of a video stream, and the search module may be provided by a server end.

In the above example, after recognizing a user intention, the video image acquisition module may control the video playback terminal to take a screenshot or capture an image according to the user intention. For example, as it is obtained from the voice information of “who is this character?” that the user intention is he wants to query information of the star in the video, the image of the current video frame is then captured. In an implementation, the human object recognition request includes an image of the current video frame, wherein the image of the current video frame is obtained through taking a screenshot or capturing an image by a playback terminal of the video stream. After a user intention is recognized, it is triggered to take a screenshot or to capture an image of the current video frame, and then a human object recognition request carrying the image of the current video frame is sent to a server.

In an embodiment of the present application, when a human object recognition request is sent by the playback terminal of the video stream, an image of the current video frame needs to be included in the human object recognition request, and then real image data may be obtained through taking a screenshot or capturing an image.

The search module is configured to provide a search service to a user. A task of the module is to extract image information in a current video frame carried in a human object recognition request on a playback terminal in a video stream, wherein the image information in the current video frame includes a feature of a human object's face, a physical characteristic, and the like. Then, these features are taken as input data to request a prediction result from the model for the human object recognition, that is, to request a human object identifier in the current video frame. Then, according to the identifier, relevant information of the human object is obtained from a knowledge base, and is sent to the playback terminal of the video stream according to a certain format combination. As shown in FIG. 3, the search module includes a feature extraction module and a human object recognition module.

The feature extraction module is used to extract a physical characteristic from an image of a current video frame, such as height, figure, clothing, a carry-on bag, a mobile phone, and other carry-on props or tools.

The physical characteristic and corresponding human object identifier, as well as relevant information of corresponding human objects are stored in a knowledge base. As the clothes and shape (shape features) of a human object will not be changed for a time period, in the absence of face information, a human object recognition may still be performed based on a physical characteristic.

Functions of the human object recognition module include training a model for human object recognition and performing a human object recognition by using the trained model. Firstly, human object information is recognized by using a human object's face, and then the human object information is associated with a physical characteristic, so that human object information may be recognized even when a human object's face is not clear or there is only a human object's back. The specific process of training and use is as follows:

a. a face recognition is performed on a human object in the video frame, and information, such as a feature of the human object's face and a star introduction, is packaged to generate a facial fingerprint. The facial fingerprint is stored in a knowledge base. Wherein, the star introduction may include information to which a user pays close attention, such as a resume and acting career of the star.

b. a physical characteristic is extracted by using a human object recognition technology, and the physical characteristic is then associated with the feature of the human object's face, or the physical characteristic is then associated with the facial fingerprint. When a human object is recognized, a physical characteristic and a facial feature may be complementarily used to improve a recognition rate. For example, in the absence of face information, a human object is recognized only from a physical characteristic.

After a human object recognition is completed on a server end, a result of the human object recognition and relevant information of the human object are sent to the playback terminal of a video stream. The result is displayed on the playback terminal of the video stream. In an example, a result display module may be built in the playback terminal of the video stream, which is used to render and display a recognition result and relevant information of a human object, after the server returns the recognition result and the relevant information of the human object.

FIG. 4 is a schematic structural diagram showing a human object recognition device according to an embodiment of the application. As shown in FIG. 4, the human object recognition device according to the embodiment of the application includes:

a receiving unit 100, configured to receive a human object recognition request corresponding to a current video frame of a video stream;

an extracting unit 200, configured to extract a physical characteristic in the current video frame;

a matching unit 300, configured to match the physical characteristic in the current video frame with a physical characteristic in a first video frame of the video stream stored in a knowledge base; and

a recognition unit 400, configured to take a first human object identifier in the first video frame as a recognition result of the human object recognition request, in a case where the physical characteristic in the current video frame is successfully matched with the physical characteristic in the first video frame.

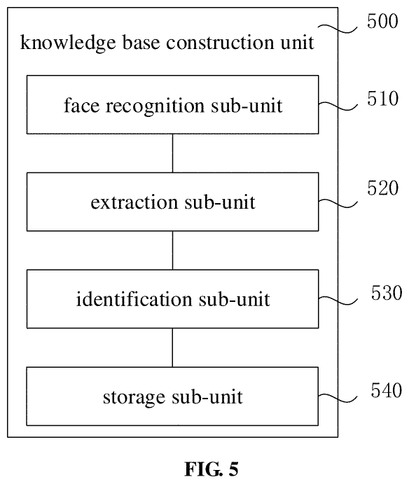

FIG. 5 is a schematic structural diagram showing a human object recognition device according to an embodiment of the application. As shown in FIG. 5, in an implementation, the above device further includes a knowledge base constructing unit 500 including:

a face recognition sub-unit 510, configured to perform a face recognition on a second video frame of the video stream to obtain a second human object identifier in the second video frame, before receiving the human object recognition request corresponding to the current video frame of the video stream, wherein a human object's face is included in an image of the second video frame;

an extraction sub-unit 520, configured to extract a physical characteristic in the second video frame and a physical characteristic in the first video frame, wherein no human object's face is included in an image of the first video frame;

an identification sub-unit 530, configured to take the second human object identifier as the first human object identifier in the first video frame, in a case where the physical characteristic in the second video frame is successfully matched with the physical characteristic in the first video frame; and

a storage sub-unit 540, configured to store the first video frame and the first human object identifier in the first video frame, in the knowledge base.

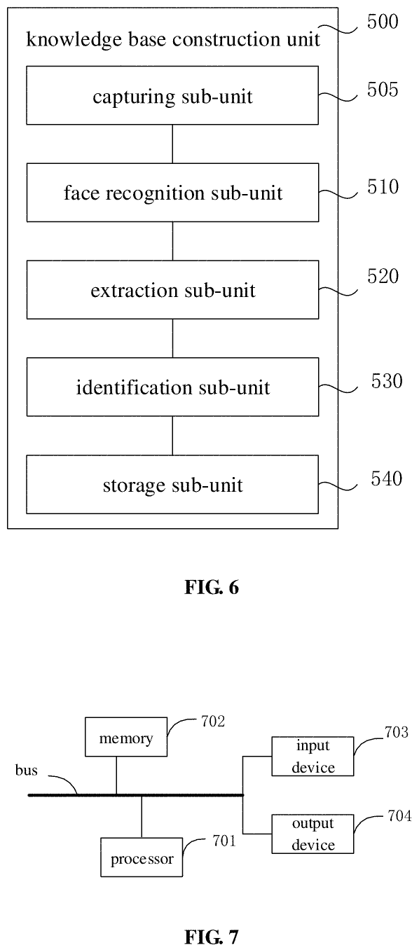

FIG. 6 is a schematic structural diagram showing a human object recognition device according to an embodiment of the application. As shown in FIG. 6, in an implementation, the knowledge base construction unit 500 further includes a capturing sub-unit 505 configured to:

capture at least one first video frame and at least one second video frame from the video stream, before performing the face recognition on the second video frame of the video stream.

In an implementation, the human object recognition request includes an image of the current video frame, and the image of the current video frame is obtained through taking a screenshot or capturing an image by a playback terminal of the video stream.

In embodiments of the application, functions of units in the human object recognition device refer to the corresponding description of the above mentioned method and thus a description thereof is omitted herein.

According to an embodiment of the present application, an electronic apparatus and a readable storage medium are provided in the present application.

As shown in FIG. 7, it is a block diagram showing an electronic apparatus for implementing a human object recognition method according to an embodiment of the application. The electronic apparatus is intended to represent various forms of digital computers, such as laptop computers, desktop computers, workbenches, personal digital assistants, servers, blade servers, mainframe computers, and other suitable computers. The Electronic apparatus may also represent various forms of mobile devices, such as personal digital processing, cellular phones, intelligent phones, wearable devices, and other similar computing devices. The components shown here, their connections and relationships, and their functions are merely for illustration, and are not intended to be limiting implementations of the application described and/or required herein.

As shown in FIG. 7, the electronic apparatus includes: one or more processors 701, a memory 702, and interfaces for connecting various components, including a high-speed interface and a low-speed interface. The various components are interconnected using different buses and may be mounted on a common motherboard or otherwise installed as required. The processor may process instructions executed within the electronic apparatus, wherein the instructions executed within the electronic apparatus includes those instructions stored in or on a memory for displaying graphic information of a graphical user interface (GUI) on an external input/output device, such as a display device coupled to the interface. In other implementations, multiple processors and/or multiple buses may be used with multiple memories and multiple storages, if desired. Similarly, multiple electronic apparatuses may be connected, each providing some necessary operations (for example, as a server array, a group of blade servers, or a multiprocessor system). A processor 701 is shown as an example in FIG. 7.

The memory 702 is a non-transitory computer-readable storage medium provided by the present application. The memory stores instructions executable by at least one processor, so that the at least one processor executes the human object recognition method provided in the present application. The non-transitory computer-readable storage medium of the present application stores computer instructions, which are used to cause a computer to execute the human object recognition method provided by the present application.

As a non-transitory computer-readable storage medium, the memory 702 may be used to store non-transitory software programs, non-transitory computer executable programs, and modules, such as a program instruction/module/unit (for example, the receiving unit 100, the extraction unit 200, the matching unit 300 and the recognition unit 400 shown in FIG. 4, the knowledge base construction unit 500, the face recognition sub-unit 510, the extraction sub-unit 520, the identification sub-unit 530 and the storage sub-unit 540 shown in FIG. 5, the capturing sub-unit 505 shown in FIG. 6) corresponding to the human object recognition method in embodiments of the present application. The processor 701 executes various functional applications and data processing of the server by running non-transitory software programs, instructions, and modules stored in the memory 702, that is, the human object recognition method in embodiments of the foregoing method is implemented.

The memory 702 may include a storage program area and a storage data area, where the storage program area may store an operating system and an application program required for at least one function; the storage data area may store data created according to the use of the electronic apparatus of the human object recognition method, etc. In addition, the memory 702 may include a high-speed random access memory, and may also include a non-transitory memory, such as at least one magnetic disk storage device, a flash memory device, or other non-transitory solid-state storage device. In some embodiments, the memory 702 may optionally include a memory remotely set relative to the processor 701, and these remote memories may be connected to the electronic apparatus for implementing the human object recognition method through a network. Examples of the above network include, but are not limited to, the Internet, an intranet, a local area network, a mobile communication network, and combinations thereof.

The electronic apparatus for implementing the human object recognition method may further include an input device 703 and an output device 704. The processor 701, the memory 702, the input device 703, and the output device 704 may be connected through a bus or in other manners. In FIG. 7, a connection through a bus is shown as an example.

The input device 703 can receive input numeric or character information, and generate key signal inputs related to user settings and function control of an electronic apparatus for implementing the human object recognition method, such as a touch screen, a keypad, a mouse, a track pad, a touchpad, a pointing stick, one or more mouse buttons, a trackball, a joystick and other input devices. The output device 704 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. In some implementations, the display device may be a touch screen.

Various implementations of the systems and technologies described herein can be implemented in digital electronic circuit systems, integrated circuit systems, Application Specific Integrated Circuits (ASICs), a computer hardware, a firmware, a software, and/or combinations thereof. These various implementation may include: implementations in one or more computer programs executable on and/or interpretable on a programmable system including at least one programmable processor, which may be a dedicated or general-purpose programmable processor that may receive data and instructions from a storage system, at least one input device, and at least one output device, and transmit the data and instructions to the storage system, the at least one input device, and the at least one output device.

These computing programs (also known as programs, software, software applications, or codes) include machine instructions of a programmable processor and can be implemented using high-level procedural and/or object-oriented programming languages, and/or assembly/machine languages. As used herein, the terms “machine-readable medium” and “computer-readable medium” refer to any computer program product, device, and/or device used to provide machine instructions and/or data to a programmable processor (for example, magnetic disks, optical disks, memories, and programmable logic devices (PLD)), include machine-readable media that receives machine instructions as machine-readable signals. The term “machine-readable signal” refers to any signal used to provide machine instructions and/or data to a programmable processor.

In order to provide interaction with a user, the systems and techniques described herein may be implemented on a computer having a display device (for example, a cathode ray tube (CRT) or a liquid crystal display (LCD) monitor) for displaying information to the user; and a keyboard and pointing device (such as a mouse or trackball) through which the user can provide input to a computer. Other kinds of devices may also be used to provide interaction with the user; for example, the feedback provided to the user may be any form of sensory feedback (for example, visual feedback, auditory feedback, or haptic feedback); and may be in any form (including acoustic input, voice input, or tactile input) to receive input from the user.

The systems and technologies described herein can be implemented in a subscriber computer of a computing system including background components (for example, as a data server), a computing system including middleware components (for example, an application server), or a computing system including front-end components (for example, a user computer with a graphical user interface or a web browser, through which the user can interact with the implementation of the systems and technologies described herein), or a computer system including such background components, middleware components, or any combination of front-end components. The components of the system may be interconnected by any form or medium of digital data communication (such as, a communication network). Examples of communication networks include: a local area network (LAN), a wide area network (WAN), and the Internet.

Computer systems can include clients and servers. The client and server are generally remote from each other and typically interact through a communication network. The client-server relationship is generated by computer programs running on the respective computers and having a client-server relationship with each other.

According to the technical solution of embodiments of the present application, points of interest are directly recognized from content related to an information behavior of a user, so that it is ensured that points of interest pushed to a user may match with intention of the user, rendering good user experience. As points of interest are directly recognized from content related to an information behavior of a user, the problem that the pushed points of interest do not meet the user's needs is avoided, thereby improving user experience.

It should be understood that various forms of processes shown above can be used to reorder, add, or delete steps. For example, the steps described in this application can be executed in parallel, sequentially, or in different orders, as long as the desired results of the technical solutions disclosed in this application can be achieved, to which no limitations are made herein.

The foregoing specific implementation manners do not constitute a limitation on the protection scope of the present application. It should be understood by those skilled in the art that various modifications, combinations, sub-combinations, and substitutions may be made according to design requirements and other factors. Any modification, equivalent replacement and improvement made within the spirit and principle of this application shall be included in the protection scope of this application.

What is claimed is:

1. A human object recognition method, comprising:
receiving a human object recognition request corresponding to a current video frame of a video stream;
extracting a physical characteristic in the current video frame;
matching the physical characteristic in the current video frame with a physical characteristic in a first video frame of the video stream stored in a knowledge base; and
taking a first human object identifier in the first video frame as a recognition result of the human object recognition request, in a case where the physical characteristic in the current video frame is successfully matched with the physical characteristic in the first video frame.

2. The human object recognition method according to claim 1, wherein before the receiving a human object recognition request corresponding to a current video frame of a video stream, the method further comprises:
performing a face recognition on a second video frame of the video stream to obtain a second human object identifier in the second video frame, wherein a human object's face is comprised in an image of the second video frame;
extracting a physical characteristic in the second video frame and a physical characteristic in the first video frame, wherein no human object's face is comprised in an image of the first video frame;
taking the second human object identifier as the first human object identifier in the first video frame, in a case where the physical characteristic in the second video frame is successfully matched with the physical characteristic in the first video frame; and
storing the first video frame and the first human object identifier in the first video frame, in the knowledge base.

3. The human object recognition method according to claim 2, wherein before the performing a face recognition on a second video frame of the video stream, the method further comprises:
capturing at least one first video frame and at least one second video frame from the video stream.

4. The human object recognition method according to claim 1, the human object recognition request comprising an image of the current video frame, wherein the image of the current video frame is obtained through taking a screenshot or capturing an image by a playback terminal of the video stream.

5. The human object recognition method according to claim 2, the human object recognition request comprising an image of the current video frame, wherein the image of the current video frame is obtained through taking a screenshot or capturing an image by a playback terminal of the video stream.

6. The human object recognition method according to claim 3, the human object recognition request comprising an image of the current video frame, wherein the image of the current video frame is obtained through taking a screenshot or capturing an image by a playback terminal of the video stream.

7. A human object recognition device, comprising:
at least one processor; and
a memory in communication connection with the at least one processor, wherein
instructions executable by the at least one processor are stored in the memory, the instructions, when executed by the at least one processor, cause the at least one processor to:
receive a human object recognition request corresponding to a current video frame of a video stream;
extract a physical characteristic in the current video frame;
match the physical characteristic in the current video frame with a physical characteristic in a first video frame of the video stream stored in a knowledge base; and
take a first human object identifier in the first video frame as a recognition result of the human object recognition request, in a case where the physical characteristic in the current video frame is successfully matched with the physical characteristic in the first video frame.

8. The human object recognition device according to claim 7, wherein the instructions, when executed by the at least one processor, cause the at least one processor to:
perform a face recognition on a second video frame of the video stream to obtain a second human object identifier in the second video frame, before receiving the human object recognition request corresponding to the current video frame of the video stream, wherein a human object's face is comprised in an image of the second video frame;
extract a physical characteristic in the second video frame and a physical characteristic in the first video frame, wherein no human object's face is comprised in an image of the first video frame;
take the second human object identifier as the first human object identifier in the first video frame, in a case where the physical characteristic in the second video frame is successfully matched with the physical characteristic in the first video frame; and
store the first video frame and the first human object identifier in the first video frame, in the knowledge base.

9. The human object recognition device according to claim 8, wherein the instructions, when executed by the at least one processor, cause the at least one processor to:
capture at least one first video frame and at least one second video frame from the video stream, before performing the face recognition on the second video frame of the video stream.

10. The human object recognition device according to claim 7, wherein the human object recognition request comprises an image of the current video frame, the image of the current video frame is obtained through taking a screenshot or capturing an image by a playback terminal of the video stream.

11. The human object recognition device according to claim 8, wherein the human object recognition request comprises an image of the current video frame, the image of the current video frame is obtained through taking a screenshot or capturing an image by a playback terminal of the video stream.

12. The human object recognition device according to claim 9, wherein the human object recognition request comprises an image of the current video frame, the image of the current video frame is obtained through taking a screenshot or capturing an image by a playback terminal of the video stream.

13. A non-transitory computer-readable storage medium comprising computer instructions stored thereon, wherein the computer instructions cause a computer to:
receive a human object recognition request corresponding to a current video frame of a video stream;
extract a physical characteristic in the current video frame;
match the physical characteristic in the current video frame with a physical characteristic in a first video frame of the video stream stored in a knowledge base; and
take a first human object identifier in the first video frame as a recognition result of the human object recognition request, in a case where the physical characteristic in the current video frame is successfully matched with the physical characteristic in the first video frame.

14. The non-transitory computer-readable storage medium according to claim 13, wherein the computer instructions cause a computer to:
perform a face recognition on a second video frame of the video stream to obtain a second human object identifier in the second video frame, wherein a human object's face is comprised in an image of the second video frame;
extract a physical characteristic in the second video frame and a physical characteristic in the first video frame, wherein no human object's face is comprised in an image of the first video frame;
take the second human object identifier as the first human object identifier in the first video frame, in a case where the physical characteristic in the second video frame is successfully matched with the physical characteristic in the first video frame; and
store the first video frame and the first human object identifier in the first video frame, in the knowledge base.

15. The non-transitory computer-readable storage medium according to claim 13, wherein the computer instructions cause a computer to:
capture at least one first video frame and at least one second video frame from the video stream.

16. The non-transitory computer-readable storage medium according to claim 13, wherein the human object recognition request comprising an image of the current video frame, wherein the image of the current video frame is obtained through taking a screenshot or capturing an image by a playback terminal of the video stream.
